(19) United States
(12) Patent Application Publication
(10) Pub. No.: US 2025/0190281 A1
(43) Pub. Date: Jun. 12, 2025

(54) Computer-Implemented Method for Performing a Process Having a Plurality of Work Steps

(71) Applicant: Robert Bosch GmbH, Stuttgart (DE)

(72) Inventors: Ajay Kumar Nagaraj, Stuttgart (DE); Daniel Zander, Oberriexingen (DE); David Huber, Gorxheimertal (DE)

(21) Appl. No.: 18/963,063

(22) Filed: Nov. 27, 2024

(30) Foreign Application Priority Data
Dec. 8, 2023 (DE) 10 2023 212 429.7

(51) Int. Cl. G06F 9/52

(52) U.S. Cl. CPC G06F 9/52

(57) ABSTRACT

A computer-implemented method is for performing a process having a plurality of work steps using one or more computing units. The method includes defining a process having a plurality of work steps. Each work step requires one or more defined inputs, and each work step generates one or more defined outputs. The outputs of some work steps are used as inputs of other work steps. The method further includes checking whether all required inputs can be generated by the process, and ordering the work steps according to the dependencies resulting from the inputs and the outputs, when the checking determines that all required inputs can be generated by the process. The method also includes instantiating the ordered work steps, and performing the instantiated work steps by one or more computing units.

This application claims priority under 35 U.S.C. § 119 to patent application no. DE 10 2023 212 429.7, filed on Dec. 8, 2023 in Germany, the disclosure of which is incorporated herein by reference in its entirety.

The disclosure relates to the processing of data, in particular, to a pre-processing of database data.

### BACKGROUND

Modern software products are often complex and process different types of data. Many different components, for example, program libraries, are often required for execution. However, the program libraries are not always available in the appropriate programming language. In other cases, they are not compatible with each other for other reasons.

The aforementioned components must interact in a non-linear manner. Whether generated procedurally or by object-oriented programming, the software often contains hard to maintain code. If further functions are implemented in such a situation, the impenetrability of the software increases along with complexity.

The interfaces of the software components become increasingly obscure and difficult to find or use or change in the increasingly complex code. In addition, ensuring type safety between components is a laborious, often neglected, task. Both aspects result in a high risk of unexpected behavior and errors.

When a project has reached a certain level of readiness, the next step is often to scale the application to many other products and use cases. With the above mentioned complexity and difficult maintainability of the pipelines involved, this task is often particularly laborious.

With complex, often intertwined functions, properly testing and reviewing the software is becoming increasingly difficult. Consequently, tests are no longer performed according to the actual requirements.

The problems mentioned above especially occur in research-oriented projects with ever-increasing and changing requirements, especially with regard to artificial intelligence (AI), data science, and others.

The object of the disclosure is thus to propose a method by means of which software for complex processes can be configured easily and quickly.

The object is achieved according to the disclosure.

### SUMMARY

According to a first aspect of the disclosure, said object is achieved by a computer-implemented method for performing a process having a plurality of work steps using one or more computing units, wherein the method comprises the steps of:
defining a process having a plurality of work steps,
wherein each work step requires one or more defined inputs, and wherein each work step generates one or more defined outputs,
wherein the outputs of some work steps are used as inputs of other work steps;
checking whether all required inputs can be generated by the process;
ordering the work steps according to the dependencies resulting from the inputs and the outputs when the checking determines that all required inputs can be generated by the process;
instantiating the ordered work steps; and
performing the instantiated work steps by one or more computing units.

The process to be performed comprises several work steps. Each work step has a task building toward the overarching goal of the process. The tasks may be different. For example, a task may be to determine new values from specified data, in particular by calculating. Another task may comprise transferring the same entered data to a different format.

The tasks may be diverse and substantially comprise any arbitrary code for executing the same. It is important that defined inputs are provided for each work step and that each work step produces defined outputs. Outputs must either be used by other work steps as inputs or serve as outputs of the entire process.

In the examples already mentioned, the output of a work step may comprise an array having the generated values. The output of the last work step or the task of the entire process may then be, for example, the creation of a table having the input values and the generated values.

The foregoing example is intended to illustrate the basic concept of the disclosure in a simple manner. In practice, processes are significantly more complex, particularly when involving pre-processing of training data for training an algorithm of machine learning.

Processes may also comprise work steps comprising various tasks such that different programming languages are differently suitable for performing the work steps. Consequently, the work steps may be defined by code in the appropriate language. As long as the inputs and outputs are clearly defined, different software packages may work together.

Once the process is defined with all work steps and it has been determined for each work step what inputs said step requires and what outputs said step generates, the process is reviewed.

The review determines whether a matching input can be generated by the process for each work step. Said review may also comprise providing input by reading in or receiving input data from a storage medium.

An exemplary method may comprise, for example, three work steps f, g, and h. The first work step f reads in data x from a storage medium, in particular from a hard drive or memory. The output is f(x). The second work step g requires the output of the first work step f as an input and generates the output g(f(x)). The third work step h requires the outputs of the other two work steps as inputs and thus generates the output h(g(f(x)), f(x)).

The review now tests whether a matching output can be used as an input for each work step. For example, if one of the work steps from the example above were to require an input referred to as k(x), the review would result in not all inputs being able to be generated by the process as only f, g and h are generated. In this case, an output may be generated to the developer indicating that the required input for the present work step is not defined. Said developer would then have to define a further work step for generating an output k(x) from the data x.

In the next step, the work steps are ordered so as to be able to be performed logically. In so doing, the work steps generating inputs to be used as outputs must be performed prior to the work steps using the outputs of the other work steps as inputs.

Back in the above example, the work steps f, g, and h, for example, could be arranged linearly in said order in sequence. Work step f requires only the input data x. Work step g requires the output of work step f and therefore must be performed after work step f. Work step h requires the output of work steps f and g and therefore must be performed after said work steps.

The present example may be trivial. However, said example illustrates the method according to the disclosure. If the process comprises more work steps, such as dozens or even hundreds, then the dependence may be confusing and difficult to handle.

When the order of the work steps is fixed, the work steps may be instantiated and then performed.

“Instanciating” is a term used in software development relating to the process of creating an instance of a class. In object-oriented programming languages, a class represents a blueprint or template for objects, while an instance is a specific realization of said class.

Instantiation comprises creating a concrete object (an instance) based on the definition of a class. Said process allocates memory for the object and initializes said object according to the properties and methods defined in the class. Instantiation is a basic step in object-oriented programming and allows classes to be used as building blocks for structuring software.

If a plurality of programs are used for the process, said programs may be aggregated as sub-programs, for example, or in a program library. Via a supervisory script, the programs may be executed, optionally in different runtime environments, in different programming languages, and/or on different hardware components, according to the determined order.

The disclosure may in particular itself be embodied as a program. A user specifies the process to be performed by defining the steps having the inputs and outputs thereof. In this way, the software developer is assisted in the creation of complex processes comprising a plurality of work steps. Creation is simplified and thus more clearly understood. The disclosure thus achieves the object thereof.

In one embodiment, the process is a pre-processing of database data, wherein the database data originates from more than one source.

Database data comprise, in particular, data originating from a plurality of databases and intended to be processed together. This may include, for example, merging data from different databases and/or concatenating data sets.

At times, transformations may be required to process data from different sources. For example, tables must be transposed or inverted. Further examples include converting, encoding, or decoding data.

By having different data formats and database structures, processes accessing data from a plurality of databases can be particularly complex. Advantageously, the present embodiment can structure said processes and thus make said processes simpler and more straightforward. For example, for each database, individual work steps may be defined to first harmonize the data, that is, transition into an identical format, and then to merge or process said data together.

In one embodiment, the process is defined in a configuration file.

The process and all work steps thereof may be stored in a configuration file. This makes said process centrally and clearly configurable, regardless of the complexity thereof. In particular, the expected inputs and the potential outputs of the individual work steps may also be stored in the configuration file.

In one embodiment, the work steps are performed using environmental variables.

Environmental variables are variables able to be input by a user when performing the work steps. The process can thereby respond to a user wishing to make changes when a particular event occurs. For example, the event may be an error message by one of the work steps or a defined intermediate result of a work step.

The user thus has the ability to respond to an event without having to adjust the configuration file and recompile the programs for performing the work steps. This makes the proposed method more flexible.

In one embodiment, the ordering of the work steps comprises topological sorting.

A “topological sorting” is a concept from graph theory finding application in computer science, in particular software development, and in particular in the context of the present embodiment. Said sorting allows for the linear arrangement of nodes in a directed acyclic graph (DAG), with the edges representing the directed connections between the nodes.

The main condition for topological sorting is that for each directed edge from a node A to a node B in a DAG, it must be ensured that A is prior to B in the sequence. Stated another way, the sorting respects the directions of the edges and ensures that each dependency is considered in a DAG.

Topological sorting can have various applications, particularly in the area of build and task scheduling in software development. For example, said sorting may be used to determine the sequence of tasks when said tasks are dependent on one another to ensure proper execution. For example, the topological sorting algorithm may be implemented using Depth-First Search (DFS).

In one embodiment, the ordering of the work steps comprises parallelizing the work steps, wherein the work steps are performed concurrently if allowed by the dependencies of input and output of the respective work step.

The present embodiment may in particular be performed together with a topological sorting, wherein the topological sorting precedes the parallelization of the work steps. The topological sorting can in particular serve to find non-achievable work steps early on, for example by way of cyclic dependencies.

In the present embodiment, non-dependent work steps are performed in parallel, requiring a parallel operating architecture of the executing computing units. Two work steps, f and g, using the same inputs x, for example, can be performed separately and parallel to one another by different computing units, in particular by different cores of a multi-core processor, or different computers within a cluster.

By parallelizing, work steps can take place simultaneously, thereby reducing the overall duration for the process to be performed. The degree of parallelization may further be coupled to the physical potential of the available computing units. For example, if the executing system comprises four computational cores, up to four work steps may be disposed parallel to each other and then performed.

In one embodiment, the process is a process for processing health data, wherein the inputs for one or more work steps comprise personal patient data, insurance data, treatment information, and/or a diagnosis, and wherein the outputs of at least one work step comprise a notification to the employer, a prescription for a drug, and/or an invoice.

Doctors, health insurance companies and, where appropriate, employers process various personal data of a patient. Data privacy must always be considered, so that only the data that is in fact needed for the actual activity is provided to each party. For example, for an employer, it is irrelevant what diagnosis was given to a patient. It is only important whether said patient is able to work or not.

In addition, there is no standard for physicians, insurance companies, or software providers in general to follow. This leads to the fact that in any medical practice, an individual process can be established that processes the patient data in its own way.

The process of the present embodiment to be performed according to the disclosure may therefore comprise work steps that merge patient data from different sources, reduce said data for data protection purposes, or send or convert patient data.

In one embodiment, the process is a process for processing logistics data, the inputs for one or more work steps comprising the location of goods, information regarding the transportation of goods, particularly in a warehouse, goods receiving information, or inventory levels, wherein the output of at least one work step comprises an inventory and/or a list of items of goods, particularly within a warehouse.

Logistics data can be complex at a plurality of levels, making said data difficult to process. For example, one potential task is to locate and inventory goods within a logistics complex. Modern logistics centers have a high throughput of goods, whereby senders and receivers may comprise different formats for the goods. For example, goods from Asia may have different details than goods produced in Europe and for the European market.

To process the data, a process can be put in place in which the individual work steps take into account the different countries and regions of origin, the type of goods, any hazard information and/or certificates, as well as tax information and/or destination information.

In one embodiment, the process is an accounting process, wherein the inputs for one or more work steps comprise information on transfers, particularly the transfer amount, the recipient, the sender, and/or the currency of the transfer, wherein the outputs of at least one work step comprise an account balance.

Institutions having a wide range of booking processes, in particular trading houses, corporations having many employees, or banks, must be able to track and allocate the type of bookings. However, the type of booking may be associated with different metadata and different formats. The allocation and/or analysis of the data may therefore be very complex.

The process to be performed may include work steps for sorting data and further processing said data according to the sorting.

In one embodiment, the process is a process for data transfer, in particular for streaming data, the inputs for one or more work steps comprising the stream history of a user profile, the recommended user hardware, the user hardware in use, the geoposition of the user, and/or a selection of a user, wherein the outputs of at least one work step comprise a media stream and/or a recommendation for a media stream.

For example, the process to be performed can be used to adjust regional requirements and license situations to the stream. In particular, for media content that is subject to local restrictions, in whole or in part, said content can be adapted to the same. Further, the creation of a consumption suggestion based on personal data may depend on the target group and/or the region in which the user is located. In the present embodiment, any framework conditions for streaming may be considered.

In a further consideration, the disclosure relates to a computer program having program code for performing a method as described above when the computer program is executed on a computer.

In a further consideration, the disclosure relates to a computer readable disk having program code of a computer program for performing a method as described above when the computer program is executed on a computer.

In a further consideration, the disclosure relates to a system for performing a process having a plurality of steps using one or more computing units, wherein the system is configured to perform a method as described above.

Overall, a method for performing a process having a plurality of steps using one or more computing units, a computer program having program code, a computer readable disk, and a system having a plurality of computing units are thus disclosed.

The described embodiments and further developments may be combined with one another as desired.

Further possible configurations, refinements, and implementations of the disclosure also comprise not explicitly mentioned combinations of features of the disclosure described above or below with respect to exemplary embodiments.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the mentioned advantages become apparent from the drawings. The illustrated elements of the drawings are not necessarily shown to scale with respect to one another.

The figures show:

FIG. 1 a schematic process flow according to an embodiment of the proposed method;

FIG. 2 five topologically sorted work steps; and

FIG. 3 a directed acyclic graph (DAG) for a method having seven work steps.

In the figures of the drawings, identical reference numbers denote identical or functionally identical elements, parts or components, unless stated otherwise.

### DETAILED DESCRIPTION

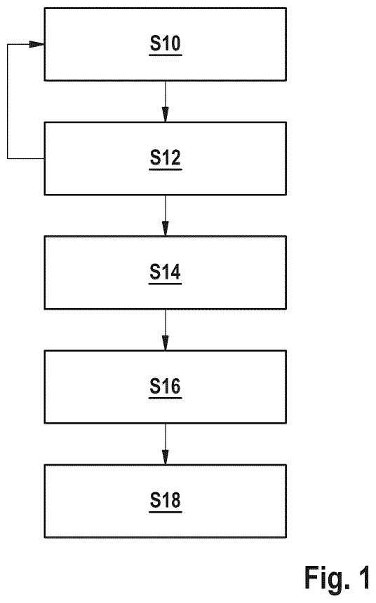

FIG. 1 schematically illustrates the process flow of the method for performing a process having a plurality of work steps.

The method begins in step S10 in that the process is defined. All work steps are described and it is determined which inputs are required for the work steps and which outputs the work steps generate. The outputs of some work steps are used as inputs to other work steps, resulting in a dependency of the work steps among each other. For example, the definition of the process may be stored in a configuration file.

In step S12, it is checked whether the inputs of each work step are available from the process. If a work step requires input that cannot be generated or procured within the process, then the check fails. In that case, the method must return to step S10 to adjust the definition of the process.

If the test is successful, then the next step, S14, may order the work steps. The ordering brings the work steps into a sequence in which said work steps are performed. Because the work steps depend on each other, said work steps cannot be performed in any arbitrary order. Generally, the work steps having outputs used as inputs by other work steps should be performed before said other work steps.

In step S16, the work steps are instantiated. This may comprise, for example, reserving memory, compiling code, or other steps typically necessary to execute program code.

In step S18, the work steps are then performed according to the defined sequence. Once all the work steps have been performed, the process is ended as such.

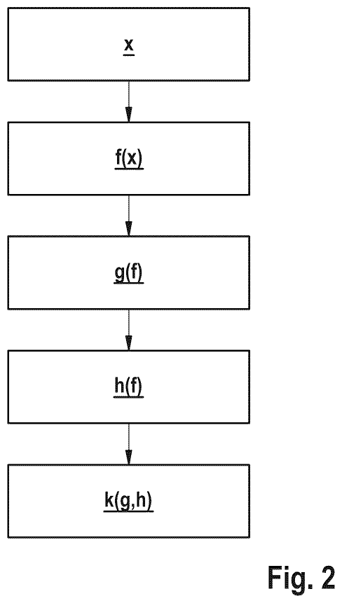

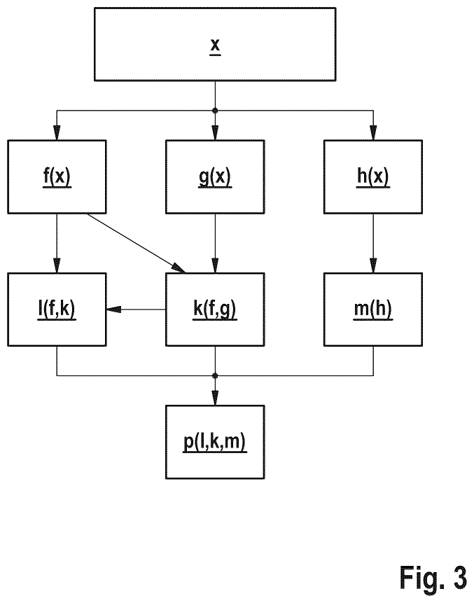

FIGS. 2 and 3 show two potential options for ordering work steps.

A topological sorting is shown in FIG. 2. The process shown here comprises five work steps. In the first step, data x is read. In a second work step f, the read data x is processed to an output f(x). The output need not be a mathematical function of the input data x.

For example, x may be a table of information and f(x) describes the transposed table.

The output f(x) is used by both of the next two work steps g and h. The work steps g and h generate the outputs g(f) and h(f), each using f(x) as an input.

Due to the dependence on the same input, the work steps g and h could be ordered next to each other. However, in topological sorting, a one-dimensional sequence of the work steps is generated so that either g or h would be performed prior to the other. In the illustrated example, g is disposed prior to h. However, the sequence could also be reversed.

In a final work step k, an output k(g, h) is generated for which the outputs g(f) and h(f) are each used as input. Because of this dependence, k must be performed after the work steps g and h. With the output of k(g,h) the process is completed. In one embodiment, the result may further be stored or sent for a particular task, for example, to control a machine or plant, or as a data packet.

FIG. 3 shows a directed acyclic graph (DAG) of another exemplary process. The process comprises seven work steps f, g, h, k, l, m, and p.

The first three work steps, f, g, and h, process read data x respectively to outputs f(x), g(x), and h(x). The three work steps therefore have no dependence on each other and can be performed in parallel. If the executing system comprises three or more computing units, the work steps f, g, and h may be performed in parallel as shown herein. Even with only two available computational units, two computational steps can be performed in parallel, also providing time savings.

The work step k requires the outputs of the work steps f and g as inputs. The work step k can therefore only be performed when the work steps f and g are completed. Because the work step k does not depend on the output of the work step h, said work step does not have to wait for the completion thereof.

The work step l requires the outputs f(x) and k(f, g) as inputs. Said work step can therefore only be performed after the work step k has been completed, whereby said work step also depends directly and indirectly on the work steps f and k. Work step l is also not dependent on the work steps h or m so that said work step can be performed independently of the same.

Work step m uses the output h(x) as input and therefore needs to be downstream of work step h. Further inputs do not require work step m, so that said work step can be performed, for example, directly after completion of the work step h. Work step m may further be performed in parallel to work steps k or l, provided the executing system has a sufficient number of computational units.

The final work step p uses the outputs l(f, k), k(f, g) and m(h) and thus depends directly or indirectly on all other work steps. Therefore, said work step must be completed at the end of the process when all the other steps are completed.

What is claimed is:

1. A computer-implemented method for performing a process having a plurality of work steps using a plurality of computing units, the method comprising:
defining a process having a plurality of work steps, each work step requires one or more defined inputs, and each work step generates one or more defined outputs, the outputs of some of the work steps are used as inputs of other of the work steps;
checking whether all required inputs can be generated by the process;
ordering the work steps according to dependencies resulting from the inputs and the outputs, when the checking determines that all required inputs can be generated by the process;
instantiating the ordered work steps; and
performing the instantiated work steps by one or more computing units,
wherein the ordering of the work steps comprises parallelizing the work steps, and
wherein the work steps are performed simultaneously when the dependencies of inputs of the respective work step permit this.

2. The computer-implemented method according to claim 1, wherein:
the process is pre-processing database data, and
the database data originates from more than one source.

3. The computer-implemented method according to claim 1, wherein the process is defined in a configuration file.

4. The computer-implemented method according to claim 1, wherein performing the work steps uses environmental variables.

5. The computer-implemented method according to claim 1, wherein the ordering of the work steps comprises topological sorting.

6. The computer-implemented method according to claim 1, wherein:
the process is a process for processing logistics data,
the inputs for one or more work steps determine a position of goods, information regarding a transport of goods, goods receipt information, or stock levels, and
the outputs of at least one work step comprise an inventory and/or a list of positions of goods.

7. The computer-implemented method according to claim 1, wherein a computer program comprises program code for performing at least portions of the method when the computer program is executed on a computer.

8. A non-transitory computer-readable data carrier comprising program code of a computer program for performing at least portions of the method according to claim 1 when the computer program is executed on a computer.

9. A system for performing a process having a plurality of work steps using one or more computing units, wherein the system is configured to perform the method according to claim 1.
